(19) United States
(12) Patent Application Publication
(10) Pub. No.: US 2002/0134480 A1
(43) Pub. Date: Sep. 26, 2002

(54) Pneumatic tire

(75) Inventors: Takafumi Taguchi, Nishinomiya-shi (JP); Mamoru Uchida, Akashi-shi (JP); Kiyoshige Muraoka, Kobe-shi (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd.

(21) Appl. No.: 10/058,140

(22) Filed: Jan. 29, 2002

Related U.S. Application Data
(63) Continuation of application No. 08/110,836, filed on Aug. 24, 1993, now abandoned.
Application No. 08/110,836 is a continuation of application No. 07/735,062, filed on Jul. 24, 1991, now abandoned.
Application No. 07/735,062 is a continuation-in-part of application No. 07/486,604, filed on Feb. 28, 1990, now abandoned.

(30) Foreign Application Priority Data
Mar. 2, 1989 (JP) 51764/1989

(51) Int. Cl. B60C 5/02

(52) U.S. Cl. 152/510

(57) ABSTRACT

A pneumatic tire having at least one layer of carcass, an inner liner made of a rubber composition (a) comprising a rubber component (a′) consisting essentially of 60 to 95% parts by weight of a halogenated butyl rubber and 5 to 40% by weight of a regular butyl rubber, and a rubber layer located between the carcass and the inner liner, which made of a rubber composition (b) comprising a diene rubber, sulfur and a sulphenamide vulcanization accelerator; the amount of sulfur in the rubber composition (b) being represented by the equation (I):

2+0.05A≦x≦5+0.05A (I)

wherein x is the amount of sulfur (PHR) and A is the percentage (% by weight) of the regular butyl rubber. The pneumatic tire of the present invention is free from a crack generation problem due to thermal hardening even if the tire heats up to a high temperature while it is running, and furthermore, is highly impermeable against air and moisture and consequently prevents a carcass cord corrosion problem from occurring. Therefore the tire can be suitably used as a tire of, for example, heavy cargo trucks.

### CROSS-REFERENCE TO RELATED APPLICATION

This application is a continuation of co-pending application Ser. No. 08/110,836, filed on Aug. 24, 1993, which is a continuation of Ser. No. 07/735,062, filed on Jul. 24, 1991, which is a continuation-in-part of Ser. No. 07/486,604 which was filed on Feb. 28, 1990, for which priority is claimed under 35 U.S.C. §120; and this application claims priority of application No. 51764/1989 filed in Japan on Mar. 2, 1989 under 35 U.S.C. §119. The entire contents of each of these applications are hereby incorporated by reference.

### BACKGROUND OF THE INVENTION

The present invention relates to a pneumatic tire, and more particularly to a heavy duty pneumatic tire having an inner liner and a rubber layer located between a carcass and the inner liner, capable of satisfactorily shutting off from air and moisture, which is free from a crack generation problem due to high internal air pressure and due to heat generated while the tire is running.

Hitherto, a pneumatic tire having a carcass and an inner liner located radially inside of the carcass is used especially for heavy duty use. The carcass has carcass cords and as the carcass cords normally steel cords are used because of their high strength. However, if air and moisture come into contact with the carcass cords made of steel cords, the cords are corroded because of the presence of the air and moisture, and consequently the cords are likely to be broken and the adhesion between the cords and surrounding rubber material of the carcass is apt to be destroyed. Thus, as a main component of the inner liner material, butyl rubber is employed because of its high impermeability against air and moisture.

With respect to a rubber composition for a tread, the carcass and suchlike portions, a rubber composition containing natural rubber is preferably employed in order to reduce the heat generation in heavy duty use. Particularly, a rubber composition used for portions adjoining the inner liner such as the carcass has a high sulfur content, in order to obtain the good adhesion between the steel cords and the rubber material of the adjoining portions. Also, in connection with this material selection, halogenated butyl rubber is widely used in the inner liner butyl rubber composition in consideration of better co-vulcanization (degree of similarity in respective optimum vulcanizing conditions such as temperature and duration time) between the carcass comprising the rubber composition containing natural rubber and the inner liner comprising butyl rubber.

However, the inner liner made solely of halogenated butyl rubber is likely to become hard under the influences of oxygen in the air and heat generated in the running tire, and this in combination with the bending stress in the running tire frequently results a crack in the inner liner. The crack, if it grows to reach the center portion of the carcass, allows air and moisture to enter, and therefore, there is a fear of corrosion of the carcass cords, and consequently as previously mentioned, the corrosion gives rise to the carcass cord breakage or a separation problem due to the adhesion destruction between the carcass cords and the surrounding rubber material.

An object of the present invention considering the problem in the prior art is to provide a heavy duty pneumatic tire which is free from a crack generation problem due to thermal hardening even if the tire heats up to a high temperature while it is running, and furthermore, highly impermeable against air and moisture and consequently capable of preventing the carcass cord corrosion from occurring.

This and the other objects of the present invention will become apparent from the following description hereinafter.

### SUMMARY OF THE INVENTION

The present invention to attain the aforementioned object was made based on the finding by the inventors that a tire satisfying every required characteristic mentioned above can be obtained when a specific inner liner made of butyl rubber wherein halogenated butyl rubber and ordinary (non-halogenated) butyl rubber are mixed in a particular proportion is combined with a rubber layer located between the carcass and the inner liner prepared from a specific rubber composition.

In accordance with the present invention, there is provided a pneumatic tire having at least one layer of carcass having one end and another end engaged with a pair of bead cores on both sides with each of the ends being turned up outwardly from inner side around each of the pair of bead cores, and an inner liner made of a rubber composition (a) located radially inside of the carcass, and a rubber layer located between the carcass and the inner liner; the rubber composition (a) used for preparing the inner liner comprising a rubber component (a′) consisting essentially of 60 to 95% by weight of a halogenated butyl rubber and 5 to 40% by weight of a regular butyl rubber, and the rubber layer being made of a rubber composition (b) comprising a diene rubber, sulfur and a sulphenamide vulcanization accelerator; the amount of sulfur in the rubber composition (b) being represented by the equation (I):

2+0.05A≦x≦5+0.05A (I)

wherein x is the amount of sulfur (PHR) and A is the percentage (% by weight) of the regular butyl rubber in the rubber component (a′).

### BRIEF EXPLANATION OF THE DRAWINGS

FIG. 1 is a cross sectional view of a pneumatic tire of the present invention along its width;

FIG. 2 is a graph showing a relationship between the hardness and the weight ratio of the halogenated butyl rubber to the regular butyl rubber in the inner liner rubber component;

FIG. 3 is a graph showing a relationship between De mattia Cut Growth and the weight ratio of the halogenated butyl rubber to the regular butyl rubber in the inner liner rubber component;

FIG. 4 is a graph showing a relationship between the adhesion between the inner liner and the rubber layer located between the carcass and the inner liner, and the weight ratio of the halogenated butyl rubber to the regular butyl rubber in the inner liner rubber component;

FIG. 5 is a graph showing a relationship between Du mattia Cut Growth and the weight ratio of the halogenated butyl rubber to the regular butyl rubber in the inner liner rubber component;

FIGS. 6 and 7 are cross sectional views of a laminate rubber constituting a pneumatic tire of the present invention, illustrating a gauge of an inner liner of the tire, respectively; and

FIG. 8 is a cross sectional view of a pneumatic tire of the present invention, illustrating a location of the inner liner.

### DETAILED DESCRIPTION

The pneumatic tire of the present invention is characterized in that, in a pneumatic tire having at least one layer of carcass having one end and another end engaged with a pair of bead cores on both sides with each of the ends being turned up outwardly from inner side around each of the pair of bead cores, and an inner liner made of a rubber composition (a) located radially inside of the carcass, the rubber composition (a) in the inner liner comprises a rubber component (a′) consisting essentially of 60 to 95% by weight of a halogenated butyl rubber and 5 to 40% by weight of a regular butyl rubber, and a rubber layer located between the carcass and the inner liner is made of a rubber composition (b) comprising a diene rubber, sulfur and a sulphenamide vulcanization accelerator, the amount of sulfur in the rubber composition (b) being represented by the equation (I):

2+0.05A≦x≦5+0.05A (I)

wherein x is the amount of sulfur (PHR) and A is a percentage (% by weight) of the regular butyl rubber in the rubber component (a′).

The halogenated butyl rubber includes a halogen as a component element, and therefore, tends to be readily hardened by heating to a high temperature. This tendency is more conspicuously observed in halogenated butyl rubber having higher halogen content.

The halogen content in one molecule is preferably 5.0% by weight or less, more preferably 3.0% by weight or less, still more preferably 2.5% by weight or less in consideration of minimizing of the aforementioned thermal hardening at a high temperature in a heated up condition. Additionally, on the basis of another consideration concerning better co-vulcanization with the rubber composition in the carcass, the halogen content is preferably 0.5% by weight or higher, more preferably 1.0% by weight or higher.

Examples of the aforementioned halogenated butyl rubber are, for instance, chlorinated butyl rubber, brominated butyl rubber and the like. Among those, brominated butyl rubber is particularly suitable because brominated butyl rubber gives better co-vulcanization with a rubber composition in the carcass.

The halogenated butyl rubber can be obtained by halogenation of an ordinary butyl rubber usually used for an automobile tire (hereinafter referred to as “regular butyl rubber”). The regular butyl rubber is isobutylene-isoprene copolymer normally having isoprene content, i.e. degree of unsaturation of the copolymer, in the range of about 0.6 to about 4.2% by mole.

Non-halogenated butyl rubber used together with the halogenated butyl rubber can be the aforementioned regular butyl rubber.

The inner liner rubber composition (a) in accordance with the present invention is prepared so that the rubber component thereof (a′) contains 60 to 95% by weight, preferably 70 to 90% by weight, of the halogenated butyl rubber and 5 to 40% by weight, preferably 10 to 30% by weight, of the regular butyl rubber.

An inner liner rubber composition with the halogenated butyl rubber content in the rubber component of less than 60% by weight has a tendency to exhibit insufficient characteristics with respect to co-vulcanization with the carcass rubber composition which results in a fear of separation problem of the inner liner from the carcass. Further, it takes a long time of period to vulcanize, resulting in low productivity. On the contrary, an inner liner rubber composition with the halogenated butyl rubber content in the rubber component of more than 95% by weight has a tendency to allow an outbreak of the crack problem.

In the present invention, the rubber layer is prepared from the rubber composition (b) comprising the diene rubber, sulfur and the sulphenamide vulcanization accelerator between the carcass and the inner liner, as mentioned above. The co-vulcanization of the rubber composition (b) with the inner liner rubber composition (a) is improved with the increase of the sulfur content in the rubber composition (b). If the sulfur content in the rubber composition (b) is so high, however, sulfur migrates to the inner liner due to the great difference (gradient) of the sulfur content between the inner liner rubber composition (a) and the rubber composition (b), since the inner liner rubber composition (a) contains zinc oxide as a main component of crosslinking agents and does not contain a large amount of sulfur. The migration of sulfur makes the modulus of the inner liner high, thus resulting in the outbreak of the crack problem in the inner liner.

When the amount of the regular butyl rubber in the inner liner rubber component (a′) and the amount of sulfur in the rubber composition (b) satisfy the equation (I):

0.05A+2≦x≦0.05A+5 (I)

wherein x is the amount of sulfur (PHR, parts per hundred rubber) and A is the percentage (% by weight) of the regular butyl rubber in the inner liner rubber component (a′), all of the above-mentioned problems can be solved.

It is preferable that the composition (b) has sulfur in an amount represented by the equation (I′):

0.05A+2.5≦x≦0.05A+4.5 (I′)

wherein A and x are as defined above.

Further, when the rubber composition (b) contains the sulphenamide vulcanization accelerator as the vulcanization accelerator, the more excellent effects can be obtained. Examples of the sulphenamide vulcanization accelerator are, for instance, DZ, TEBS, NOBS, CZ, and the like.

The amount of the sulphenamide vulcanization accelerator is not particularly limited, and is suitably decided depending on the amount of sulfur, the kind of the accelerator, and the like. It is general that the amount of the accelerator is from 0.5 to 3 PHR.

Examples of the diene rubber used in the rubber composition (b) are, for instance, a natural rubber (NR), isoprene rubber (IR), styrene-butadiene rubber (SBR), butadiene rubber (BR), and the like.

The inner liner rubber composition can be obtained through a process wherein a rubber component consisting essentially of specified respective amounts of the halogenated butyl rubber and the regular butyl rubber is subjected to heating and kneading so as to become the particular rubber composition and the composition is shaped into desired form. The rubber composition may include other ingredients which are normally included in a conventional rubber composition. Examples of the aforementioned other ingredients are: an ingredient for improving reinforcement of the rubber, e.g. carbon black; an ingredient serving as vulcanizing assistant and improving workability, e.g. process oil; an ingredient acting on butyl rubber as vulcanization-retarder and preventing scorching, e.g. magnesium oxide, mercaptobenzothiazyl disulfide (hereinafter referred to as MBTS); a vulcanization accelerator, e.g. zinc oxide; a vulcanizing agent, e.g. sulfur; and the like.

It is general that the inner liner rubber is composition (a) contains 0.1 to 2 PHR of sulfur.

Also, the rubber composition (b) can be obtained by heating and kneading the diene rubber, sulfur with the specified amount and the sulphenamide vulcanization accelerator in a usual manner, and the composition is shaped into a desired form. The composition (b) may include other ingredients which are normally included in a conventional rubber composition used in the inner liner. Examples of the aforementioned other ingredients are: an ingredient for improving reinforcement of the rubber, e.g. carbon black; an ingredient improving workability, e.g. process oil; a vulcanization accelerator other than the sulphenamide vulcanization accelerator, e.g. zinc oxide; a vulcanizing agent other than sulfur; and the like. Also, a cobalt salt of organic acid may be suitably added for improving the adhesion between the steel cords and the rubber.

Next, there is provided an explanation of a pneumatic tire of the present invention referring to the accompanying drawing.

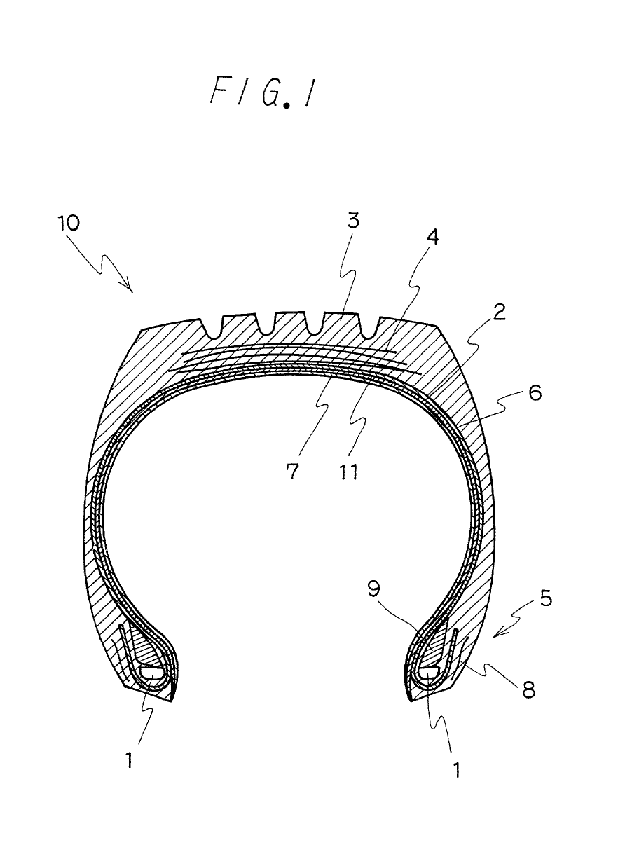

FIG. 1 is a cross sectional view along width showing a pneumatic tire of 11R 24.5 size in accordance with the present invention.

A tire 10 has a tread portion 3, side wall portions 6 extending from both ends of the tread portion 3 toward respective sides of the tire, and bead portions 5 located respectively at radially inside ends of both side wall portions 6. Both ends of a carcass 2 are turned up outwardly from axially inner side respectively around a pair of bead cores 1 respectively on the right hand side and on the left hand side so as to be engaged with the bead cores 1 in the bead portions 5. In the illustrated embodiment, the carcass 2 comprises one layer of parallel steel cords laid in good order at an angle of about 90 degrees relative to the peripheral (hoop) direction. However the carcass may comprises two or more layers as occasion demands.

In addition, a reinforcing layer 8 is provided on axially outside of the carcass cord turning up portion, and a bead apex 9 is located on radially outside adjacent to the bead core 1.

Further, a belt layer 4 comprising steel cords is located at a place which is on radially inside of the tread 3 and which is also on radially outside of the carcass 2. The belt layer 4 comprises a plurality of cord layers with cord directions intersecting at a relatively small angle.

The pneumatic tire 10 has an inner liner 7 on radially inside adjacent to the carcass 2 through a rubber layer 11, and as mentioned previously, the inner liner 7 is made of; the rubber composition containing the halogenated butyl rubber of 60 to 95% by weight and the 30 regular butyl rubber of 5 to 40% by weight; and other ingredients added as occasion demands.

The rubber layer 11 located between the inner liner 7 and the carcass 2 is made of the rubber composition (b) comprising the diene rubber, the sulphenamide vulcanization accelerator and sulfur having the amount represented by the equation (I):

0.05A+2≦x≦0.05A+5 (I)

wherein x and A are as defined above.

In the present invention, it is preferable that a gauge (thickness) of the inner liner satisfies the equation (II):

0.2≦C/B<1 (II)

wherein B (mm) is a distance from the radially inside end of the inner liner 7 to the steel cord 12 in the carcass 2 and C (mm) is a gauge (thickness) of the inner liner 7, provided that B≦5 mm, and the equation (III):

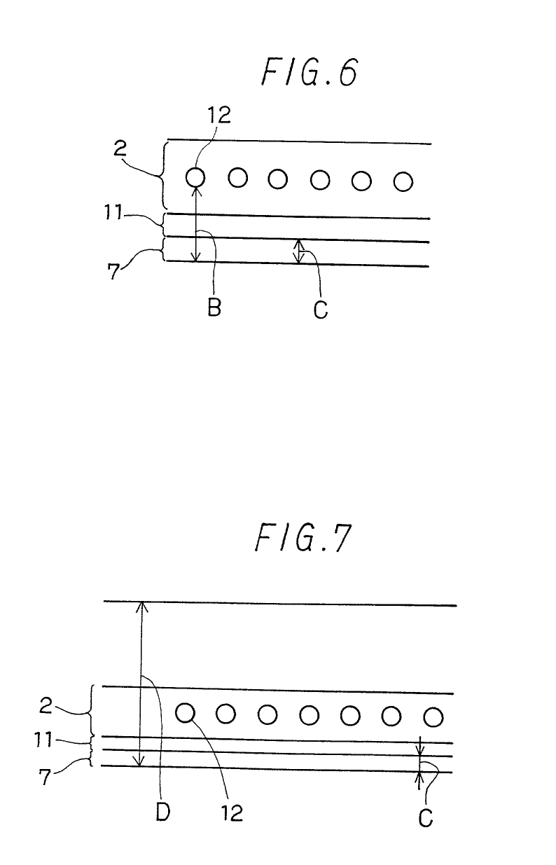

0.05≦C/D≦0.5 (III)

wherein D (mm) is a gauge (thickness) of the thinnest thickness of the laminate rubber constituting the tire, and C is as defined above. FIGS. 6 and 7 are the cross sectional views of a laminate rubber constituting the tire, respectively.

The inner liner is required to have a low moisture-permeability in order to prevent the corrosion of the steel cords and to have a low air(gas)-permeability in order to prevent the deterioration of the rubber material due to oxygen and in order to retain an air pressure of the tire at a predetermined pressure. In order to prevent the permeation of moisture, it is preferable that the thickness C of the inner liner is made as thick as possible. If the thickness C of the inner liner is equal to the distance B from the radially inside end of the inner liner to the steel cord, however, the adhesion between the steel cords and the rubber becomes poor. Accordingly, it is required that B is more than C (C/B<1) On the other hand, when the ratio of the thickness C of the inner liner to the distance B is less than 0.2, the impermeability to moisture becomes bad. (See, FIG. 6). The thickness of the distance B is 5 mm or less.

Also, when the ratio of the thickness C of the inner liner to the thickness D of the laminate rubber constituting the tire, the distance D being a thickness of the thinnest part of the laminate rubber, is less than 0.05 (C/D<0.05), the retention ratio of the inner D pressure of the tire is bad. Also, when the ratio of C to D is more than 0.5 (C/D>0.5), the bad rolling resistance of the inner liner exerts a bad influence on the tire. It is more preferable that the ratio of the thickness C of the inner liner to the thickness D of the laminate rubber is from 0.1 to 0.4 (0.1≦C/D≦0.4). (See FIG. 7.)

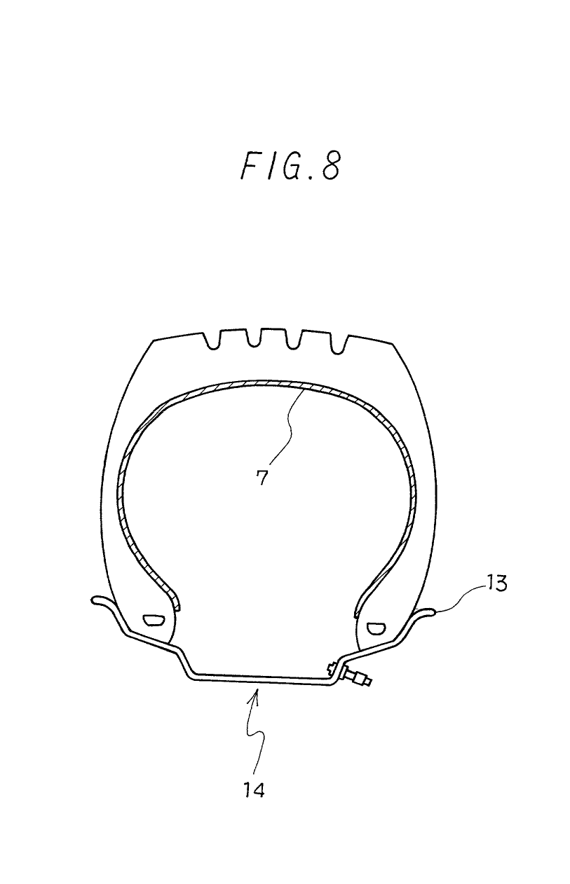

Further, it is preferable that the inner liner 7 is provided so that the edges thereof are located on a level below the position of a rim flange 13 when the tire is attached to a rim 14. FIG. 8 is the cross sectional view of the pneumatic tire of the present invention, illustrating the location of the inner liner.

The present invention is more specifically described and explained by means of the following Examples in which all per cents and parts are by weight unless otherwise noted. It is to be understood that the present invention is not limited to the Examples, and various changes and modifications may be made in the invention without departing from the spirit and scope thereof.

### EXAMPLE 1

In accordance with the mixing proportion shown in Table 1, halogenated butyl rubber (Bromobutyl 2255 (halogen content: 2%) ; available from Exxon chemical Japan, Ltd., trade name), non-halogenated butyl rubber(Butyl 265; available from Exxon Chemical Japan Ltd., trade name), carbon black (Niteron 55S; available from Shin-Nittetsu Kagaku Kabushiki Kaisha, trade name), process oil, stearic acid, magnesium oxide and MBTS were mixed and kneaded. Then, after zinc oxide and sulfur were added, the mixture was further mixed and kneaded, and subsequently test pieces (55 mm-long, 55 mm-wide, 4 mm-thick) were prepared.

For the purpose of property measurement of the obtained test pieces, (a) scorching time T_{L+2}, (b) 90% vulcanizing time and (c) maximum torque were measured through rheometer test, and further after-vulcanization-properties (hardness and De mattia Cut Growth) were also investigated. These measurements were conducted in the following manner. The measurement results are also shown in Table 1.

Values of scorching time T_{L+2}, 90% vulcanizing time and maximum torque in rheometer test were measured at measurement temperature of 150° C. with a rheometer R-100 (available from Monsant Japan Ltd., trade name) being used.

De mattia Cut Growth as one of after-vulcanization-properties was measured as follows: A rubber composition (b) for the rubber layer between the carcass and the inner liner, comprising a natural rubber and 3 PHR of sulfur adhered to the test piece as obtained above, and it was pressed and vulcanized. After peeling off the rubber for the layer between the carcass and the inner liner from the piece, a 2 mm-width crack was prepared in a ditch provided on the center of the piece. The thus obtained test piece was subjected to bending with De mattia fatigue test apparatus used, so that the number of times of bending required for the crack width growth by 1 mm was investigated respectively both in the normal (new) condition and in the aged condition in which a test piece had been aged through heating for 150 hours at a temperature of 110° C. The results are shown in Table 1.

TABLE 1

| | Components (parts) | | | | | | | | |
|---|---|---|---|---|---|---|---|---|---|
| Test | butyl rubber | | | | | | | | |
| Piece | halogenated | regular | carbon | process | stearic | magnesium | | zinc | |
| No. | butyl rubber | butyl rubber | black | oil | acid | oxide | MBTS | oxide | sulfur |
| A | 65 | 35 | 60 | 10 | 2 | 0.5 | 1.5 | 3 | 0.5 |
| B | 70 | 30 | 60 | 10 | 2 | 0.5 | 1.5 | 3 | 0.5 |
| C | 80 | 20 | 60 | 10 | 2 | 0.5 | 1.5 | 3 | 0.5 |
| D | 90 | 10 | 60 | 10 | 2 | 0.5 | 1.5 | 3 | 0.5 |
| E | 95 | 5 | 60 | 10 | 2 | 0.5 | 1.5 | 3 | 0.5 |
| F | 55 | 45 | 60 | 10 | 2 | 0.5 | 1.5 | 3 | 0.5 |
| G | 100 | 0 | 60 | 10 | 2 | 0.5 | 1.5 | 3 | 0.5 |

| | Measured Properties | | | | | | | | |
|---|---|---|---|---|---|---|---|---|---|
| | rheometer test | | | after-vulcanizing-properties | | | | | |
| | | 90% vul- | maximum | | Hardness (JIS A) | | | Dematcher Cut | |
| Test | scorching | canizing | torque | | aged | aged | aged | Growth (number | |
| Piece | time | time | (pounds- | | (50 | (100 | (150 | of times) | |
| No. | (minutes) | (minutes) | inches) | new | hours) | hours) | hours) | new | aged |
| A | 7.5 | 126.0 | 24.4 | 50 | 51 | 51 | 52 | 40 × 10⁶ | 14 × 10⁶ |
| B | 6.5 | 120.5 | 25.2 | 51 | 52 | 54 | 55 | 40 × 10⁶ | 11 × 10⁶ |
| | | | | | | | | or more | |
| C | 5.1 | 110.3 | 26.5 | 53 | 55 | 56 | 58 | 40 × 10⁶ | 7 × 10⁶ |
| | | | | | | | | or more | |
| D | 4.6 | 100.1 | 28.3 | 56 | 58 | 60 | 62 | 23 × 10⁶ | 2.3 × 10⁶ |
| E | 4.3 | 91.7 | 29.2 | 57 | 59 | 62 | 64 | 15 × 10⁶ | 1.4 × 10⁶ |
| F | 9.0 | 138.5 | 23.4 | 48 | 48 | 49 | 49 | 40 × 10⁶ | 16 × 10⁶ |
| G | 4.0 | 86.5 | 30.1 | 58 | 61 | 63 | 66 | 5 × 10⁶ | 0.2 × 10⁶ |

Then, 100 parts of a natural rubber, 50 parts of HAF grade carbon black, 2 parts of a process oil, 1 part of 2,2,4-trimethyl-1,2-dihydroquinoline polymer as an antioxidant, 2 parts of cobalt stearate (cobalt content: 9%), 10 parts of zinc oxide, sulfur having an amount shown in Table 2 and 1 part of a vulcanization accelerator shown in Table 2 were mixed and kneaded to give a rubber composition (b). The obtained rubber composition (b) was adhered to the test piece used in the rheometer test, and vulcanizing, and thereafter the adhesion (Kfg/cm) was determined based on procedure of JIS (Japanese Industries Standards) K 6301. The results are shown in Table 2.

TABLE 2

| | Rubber composition | | | | | | | |
|---|---|---|---|---|---|---|---|---|
| | of inner liner | | | | | | | |
| | Weight ratio | 100 | 95 | 90 | 80 | 70 | 65 | 55 |
| | of halogen- | | | | | | | |
| | ated butyl | | | | | | | |
| | rubber (%) | | | | | | | |
| | Weight ratio | 0 | 5 | 10 | 20 | 30 | 35 | 45 |
| | of regular | | | | | | | |
| Rubber composition | butyl | | | | | | | |
| (b) | rubber (%) | | | | | | | |

| | |
|---|---|
| Amount | |
| of sulfur | Kind of |
| (PHR) | accelerator |

| | | | | | | | | |
|---|---|---|---|---|---|---|---|---|
| 2 | DZ | 6.0 | 5.6 | 5.0 | 3.5 | — | — | — |
| 3 | DZ | 7.0 | 7.0 | 6.8 | 6.1 | 4.8 | — | — |
| 4 | DZ | 8.0 | 8.0 | 8.0 | 8.0 | 7.5 | 6.5 | 5.0 |
| 5 | DZ | 8.5 | 8.5 | 8.5 | 8.5 | 8.3 | 8.2 | 7.0 |
| 4 | TBBS | 8.2 | 8.2 | 8.2 | 8.1 | 7.8 | 6.5 | 5.0 |
| 4 | DM | 5.8 | 5.4 | 5.3 | 5.2 | 4.0 | 3.8 | 3.0 |
| 4 | TT | 5.5 | 5.5 | 5.5 | 5.5 | 5.0 | 5.0 | 5.0 |

(kgf/cm)

Using the same rubber composition (b) as used in the adhesion test (the amount of sulfur and the kind of the vulcanization accelerator shown in Table 3), the Demattia fatigue test was conducted in the same manner as above. The results are shown in Table 3.

TABLE 3

| | Rubber composition | | | | | | | |
|---|---|---|---|---|---|---|---|---|
| | of inner liner | | | | | | | |
| | Weight ratio | 100 | 95 | 90 | 80 | 70 | 65 | 55 |
| | of halogen- | | | | | | | |
| | ated butyl | | | | | | | |
| | rubber (%) | | | | | | | |
| | Weight ratio | 0 | 5 | 10 | 20 | 30 | 35 | 45 |
| | of regular | | | | | | | |
| Rubber composition | butyl | | | | | | | |
| (b) | rubber (%) | | | | | | | |

| | |
|---|---|
| Amount | |
| of sulfur | Kind of |
| (PHR) | accelerator |

| | | | | | | | | |
|---|---|---|---|---|---|---|---|---|
| 3 | DZ | 5 | 15 | 21 | 40 | 50 | 50 | 50 |
| 4 | DZ | 5 | 15 | 21 | 38 | 50 | 50 | 50 |
| 5 | DZ | 4 | 13 | 21 | 33 | 43 | 45 | 50 |
| 6 | DZ | 3 | 7 | 11 | 15 | 21 | 25 | 36 |
| 7 | DZ | 2 | 2 | 3 | 4 | 8 | 10 | 20 |
| 8 | DZ | 0.5 | 1 | 2.5 | 2.5 | 4 | 5 | 9 |

×10⁶ (number of times)

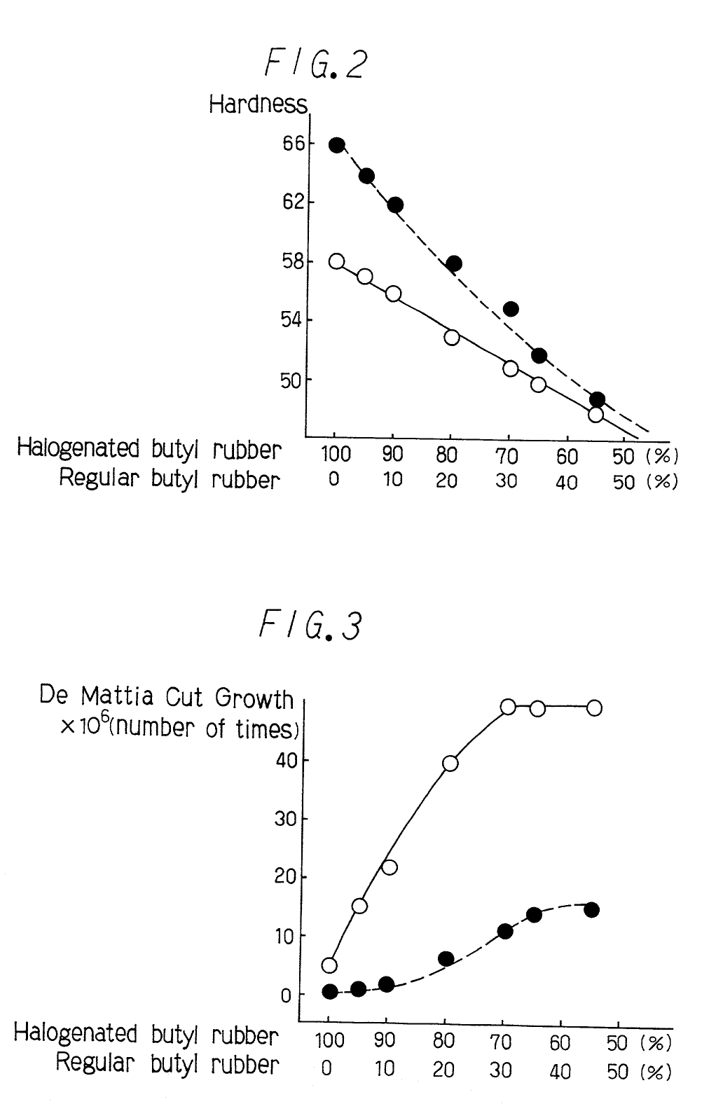

FIG. 2 is a graph showing a relationship between the hardness and the weight ratio of the halogenated butyl rubber to the regular butyl rubber in the inner liner rubber component wherein ∘-∘ shows the results of the hardness of the new sample and ●---● shows the results of the hardness of the sample aged for 150 hours. FIG. 3 is a graph showing a relationship between De mattia Cut Growth and the weight ratio of the halogenated butyl rubber to the regular butyl rubber in the inner liner rubber component wherein ∘-∘ shows the results of De mattia Cut Growth of the new sample and ●---● shows the results of the aged sample. As shown in Table 1 and FIGS. 2 and 3, it would be understood that the De mattia Cut Growth and the deterioration of the physical properties of the inner liner aged by heating are improved with the increase of the weight ratio of the regular butyl rubber to the halogenated butyl rubber in the inner liner rubber composition. However, even if more than 40% by weight of the regular butyl rubber is used, the improving effects cannot be increased more.

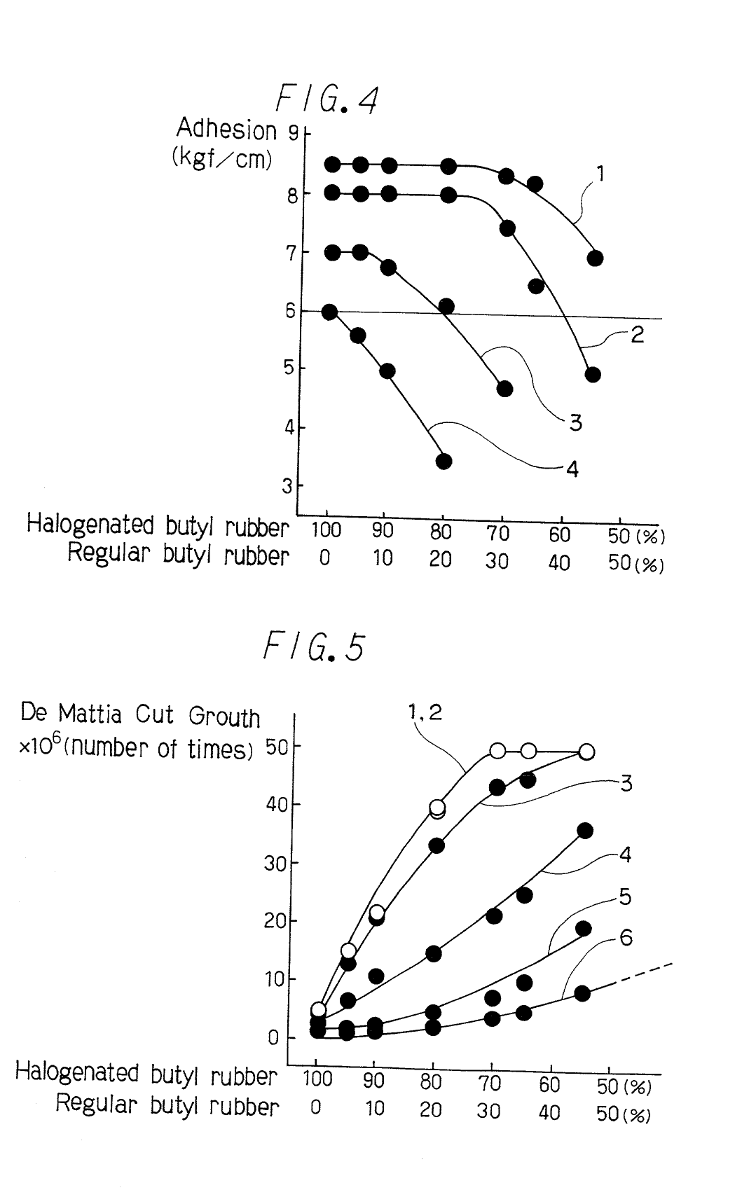

FIG. 4 is a graph showing a relationship between the adhesion and the weight ratio of the halogenated butyl rubber to the regular butyl rubber in the inner liner rubber component wherein the line 1 shows the results of the case where the sulfur content in the adjoining portion rubber composition is 5 PHR, the line 2 shows the results of the case where the sulfur content is 4 PHR, the line 3 shows the results of the case where the sulfur content is 3 PHR and the line 4 shows the results of the case where the sulfur content is 2 PHR.

FIG. 5 is a graph showing a relationship between Du mattia Cut Growth and the weight ratio of the halogenated butyl rubber to the regular butyl rubber in the inner liner rubber component wherein the lines 1 and 2 show the results of the cases where the sulfur content in the rubber composition (b) is 3 PHR and 4 PHR, respectively, the line 3 shows, the results of the case where the sulfur content is 5 PHR, the line 4 shows the results of the case where the sulfur content is 6 PHR, the line 5 shows the results of the case where the sulfur content is 7 PHR, and the line 6 shows the results of the case where the sulfur content is 8 PHR.

As shown in Table 2 and FIG. 4, the adhesion between the inner liner and the adjoining rubber layer becomes excellent with the increase of the sulfur content in the rubber layer between the carcass and the inner liner. However, as shown in Table 3 and FIG. 5, when the sulfur content is more than (0.05A+5) PHR, Du mattia Cut Growth becomes worse. Also, as shown in Table 2, when as the vulcanization accelerator, the sulphenamide accelerators such as DZ and TBBS are used, the adhesion between the inner liner and the adjoining rubber layer is excellent.

### EXAMPLE 2 AND COMPARATIVE EXAMPLE 1

pneumatic tire of 11R 24.5 size having a construction shown in FIG. 1 was prepared in which the same inner liner rubber composition as Example 1 wherein the rubber component was 80% of the halogenated butyl rubber and 20% of the regular butyl rubber was applied to the inner liner and the same rubber composition (b) as Example 1 containing 4 PHR of sulfur and DZ as the vulcanization accelerator was applied to the rubber layer between the carcass and the inner liner.

Another pneumatic tire of the same size and the same construction as Example 2 was prepared in which the same inner liner rubber composition as Example 1 wherein the rubber component is 100% of the halogenated butyl rubber was applied to the inner liner, and the same rubber composition (b) as Example 1 containing 4 PHR of sulfur and DZ as the vulcanization accelerator was applied to the rubber layer between the carcass and the inner liner.

These tires were subjected to the running test for 600 hours at internal air pressure of 8.0 kg/cm², load of 6200 kg and speed of 20 km/hour, so that the change in the inner liner hardness between before and after the running were determined. The results are shown in Table 4.

In addition, a crack having a depth of 1 mm and a length of 1 mm had been prepared on the buttress portion of each tire prior to the running, so that each crack growth (mm) was measured after the aforementioned running of the tire under the described condition. The results are also shown in Table 4.

TABLE 4

| | Inner Liner | Rubber composition | Inner Liner Hardness (JIS A) | | Crack Growth |
|---|---|---|---|---|---|
| Ex. No. | rubber component | (b) | before running | after running | (mm) |
| Ex. 2 | Halogenated butyl | Sulfur Content: 4 PHR | 53 | 56 | 0 |
| | rubber: 80% | | | | |
| | Regular butyl | Accerelator: DZ | | | |
| | rubber: 20% | | | | |
| Com. Ex. 1 | Halogenated butyl | Sulfur content: 4 PHR | 58 | 67 | 1.5 |
| | rubber: 100% | | | | |

The results shown in Table 4 demonstrate that even if the tire of Example 2 has a crack on its buttress portion the crack does not grow, and therefore that the tire of Example 2 is suitable for practical use.

Thus, the pneumatic tire of the present invention is free from a crack generation problem due to thermal hardening even if the tire heats up to a high temperature while it is running, and furthermore, the pneumatic tire of the present invention is highly impermeable against air and moisture and consequently prevents a carcass cord corrosion problem from occurring. Therefore the pneumatic tire of the present invention can be suitably used as a tire of, for example, heavy cargo truck.

In addition to the ingredients used in the Examples, other ingredients can be used in the Examples as set forth in the specification to obtain substantially the same results.

What we claim is:

1. A pneumatic tire having a carcass of at least one layer, said carcass having a pair of ends engaged with a pair of bead cores on both sides with each of the ends being turned up outwardly from an inner side around each of the pair of bead cores, an inner liner made of a first rubber composition disposed radially inside of the carcass, and a rubber layer disposed between said carcass and said inner liner;
the rubber component of said first rubber composition consisting essentially of 60 to 95% by weight of a halogenated butyl rubber and 5 to 40% by weight of a regular butyl rubber, said regular butyl rubber being an isobutylene-isoprene copolymer rubber, and
said rubber layer being made of a second rubber composition including a diene rubber, sulfur and a sulfenamide vulcanization accelerator;
the amount of sulfur of said second rubber composition being represented by the equation (I):
2+0.05A≦x≦5+0.05A (I)
wherein X is the amount of sulfur in parts per hundred of the diene rubber of said rubber layer and A is the percentage by weight of the regular butyl rubber in the rubber component.

2. The tire of claim 1, wherein the thickness of said inner liner satisfies the equation (II):
$$0.2 \leq \frac{C}{B} < 1 \qquad ( II )$$
wherein B is a distance in millimeters from the radially inside surface of said inner liner to the steel cord in said carcass and C is the thickness in millimeters of said inner liner, provided that B≦5 millimeters, and the equation (III):
$$0.05 \leq \frac{C}{D} \leq 0.5 \qquad ( III )$$
wherein D is a thickness in millimeters of the thinnest thickness of a laminate rubber constituting the tire, and C is as defined above.

3. The tire of claim 1, wherein said inner liner is provided so that the edges thereof are located on a level radially below the position of a rim flange.

4. The tire of claim 1, wherein said diene rubber is at least one member selected from the group consisting of a natural rubber, an isoprene rubber, a styrene-butadiene rubber and a butadiene rubber.

5. The tire of claim 1, wherein said first rubber composition includes an amount of sulfur less than that contained in said second rubber composition.

6. A pneumatic tire having a carcass of at least one layer, said carcass having a pair of ends engaged with a pair of bead cores on both sides with each of the ends being turned up outwardly from an inner side around each of the pair of bead cores, an inner liner made of a first rubber composition disposed radially inside of the carcass, and a rubber layer disposed between said carcass and said inner liner;
the rubber component of said first rubber composition consisting essentially of 60 to 95% by weight of a halogenated butyl rubber and 5 to 40% by weight of a regular butyl rubber, said regular butyl rubber being an isobutylene-isoprene copolymer rubber, and
said rubber layer being made of a second rubber composition including a diene rubber, sulfur, a sulfenamide vulcanization accelerator and a reinforcing ingredient, said reinforcing ingredient being carbon black;
the amount of sulfur of said second rubber composition being represented by the equation (I):
2+0.05A≦x≦5+0.05A (I)
wherein X is the amount of sulfur in parts per hundred of the diene rubber of said rubber layer and A is the percentage by weight of the regular butyl rubber in the rubber component.

7. The tire of claim 6, wherein said diene rubber in said second rubber composition is a member selected from the group consisting of natural rubber, isoprene rubber and butadiene rubber.
